(19) United States
(12) Patent Application Publication
(10) Pub. No.: US 2025/0125554 A1
(43) Pub. Date: Apr. 17, 2025

(54) ELECTRONIC APPARATUS

(71) Applicant: Lenovo (Singapore) Pte. Ltd., Singapore (SG)

(72) Inventors: Keita Suzuki, Kanagawa (JP); Tatsuya Ushioda, Kanagawa (JP)

(73) Assignee: Lenovo (Singapore) Pte. Ltd., Singapore (SG)

(21) Appl. No.: 18/807,911

(22) Filed: Aug. 16, 2024

(30) Foreign Application Priority Data
Oct. 12, 2023 (JP) 2023-176806

(51) Int. Cl. H01R 13/52; G06F 1/16

(52) U.S. Cl. CPC H01R 13/5213; G06F 1/1656

(57) ABSTRACT

An electronic apparatus includes: a flat chassis composed of an upper plate, a lower plate, and a side plate having four peripheral sides; a substrate provided in the chassis; a receptacle connector which is attached to the substrate and has a plug insertion opening directed to a side of the chassis; a cover fitting cutout formed in the side plate of the chassis so as to extend from a point, where the plug insertion opening is exposed, to the lower plate; and a cover assembly attached to the substrate. The cover assembly includes: a block detachably fixed to the substrate, and a cover which is journaled to the block and rotates to close the cover fitting cutout in a closed state and expose the plug insertion opening in an open state.

### CROSS-REFERENCE TO RELATED APPLICATIONS

This application claims priority to Japanese Patent Application No. 2023-176806 filed on Oct. 12, 2023, the contents of which are hereby incorporated herein by reference in their entirety.

### TECHNICAL FIELD

The present invention relates to an electronic apparatus having a receptacle connector on a side of the chassis thereof.

### BACKGROUND

A laptop or tablet personal computer has a connector on a side of a flat chassis thereof. As illustrated in Japanese Unexamined Patent Application Publication No. 09-330146, an openable cover may be provided to protect a connector provided on a side.

The above-described cover that protects a connector is adapted to be rotatable with respect to the chassis by a hinge and has a mechanism that heavily depends on the shape of a chassis, thus leading to poor compatibility among different models.

### SUMMARY

One or more embodiments of the invention provide an electronic apparatus with a connector protection cover that has high compatibility among models.

An electronic apparatus according to one or more embodiments of the present invention has a flat chassis composed of an upper plate, a lower plate, and a side plate having four peripheral sides; a substrate provided in the chassis; a receptacle connector which is attached to the substrate and has a plug insertion opening directed to a side of the chassis; a cover fitting cutout formed in the side plate of the chassis so as to extend from a point, where the plug insertion opening is exposed, to the lower plate; and a cover assembly attached to the substrate, wherein the cover assembly has a block detachably fixed to the substrate, and a cover which is journaled to the block and rotates to close the cover fitting cutout in a closed state and expose the plug insertion opening in an open state.

According to one or more embodiments of the present invention, the cover that exposes the plug insertion opening in the open state can be made in the assembly form together with the block, thereby providing high compatibility among models without depending on the shape of each model.

### BRIEF DESCRIPTION OF THE DRAWINGS

FIG. 1 is a perspective view of a laptop PC, which is an electronic apparatus according to one or more embodiments of the present invention.

FIG. 2 is a partially cutaway perspective view illustrating a receptacle connector and the surroundings thereof in a side plate with the cover closed.

FIG. 3 is a perspective view illustrating the receptacle connector and the surroundings thereof in the side plate with the cover open.

FIG. 4 is a perspective view illustrating the receptacle connector and the surroundings thereof in the side plate with a plug connector connected.

FIG. 5 is a sectional view taken along line V-V in FIG. 2.

FIG. 6 is a sectional view taken along line VI-VI in FIG. 2.

FIG. 7 is an exploded perspective view of the receptacle connector and the surrounding components thereof.

FIG. 8 is a perspective view of the cover.

FIG. 9 is a perspective view of a block.

FIG. 10 is a perspective view of a cover assembly.

FIG. 11 is a sectional side view taken along line XI-XI in FIG. 3.

FIG. 12 is a sectional side view taken along line XII-XII in FIG. 4.

FIG. 13 is a sectional view of the receptacle connector and the surrounding section thereof when the plug connector is pushed down by a rather large force.

### DETAILED DESCRIPTION

The following will describe in detail embodiments of an electronic apparatus according to the present invention with reference to the accompanying drawings. It should be noted that the present invention is not limited by these embodiments.

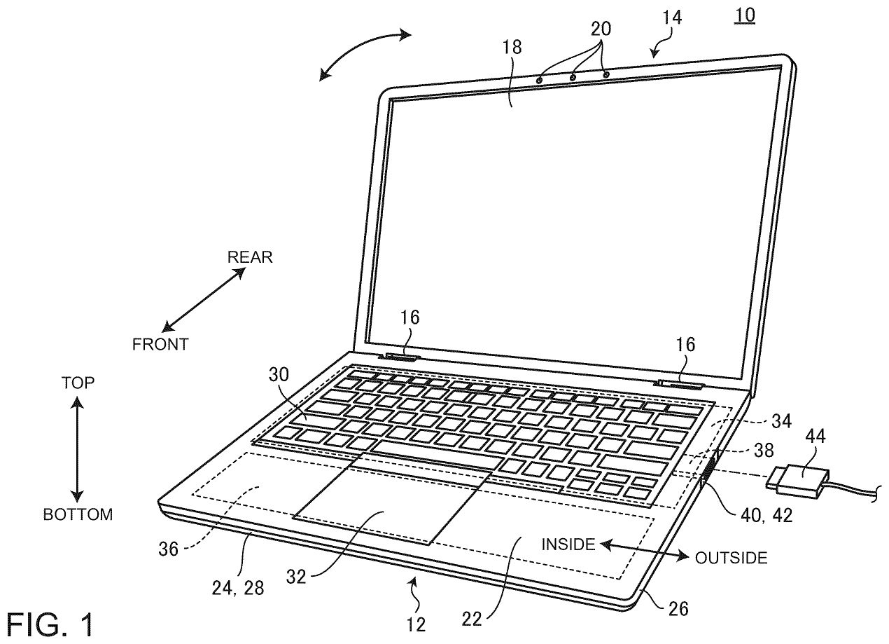

FIG. 1 is a perspective view of a laptop PC, which is an electronic apparatus 10 according to one or more embodiments of the present invention. The electronic apparatus according to the present invention may be any apparatus that has a flat chassis, such as, for example, a mobile tablet terminal.

The electronic apparatus 10 has a lid body 14, which can be opened and closed by hinges 16 with respect to a chassis 12, and becomes compact when the lid body 14 is closed, making the electronic apparatus 10 ideally suited for mobile use. The front of the lid body 14 is provided with a display device 18, which occupies most of the area of the lid body 14, electronic devices 20, and the like. With respect to the chassis 12, the side facing the display device 18 with the lid body 14 closed will be referred to as top, and the opposite side will be referred to as bottom. Around a receptacle connector 38, which will be described later, a lateral of the chassis 12 will be referred to as outside, and the opposite thereof, which is the inside of the chassis 12, will be referred to as inside. However, the use mode of the electronic apparatus 10 is not limited to these orientations.

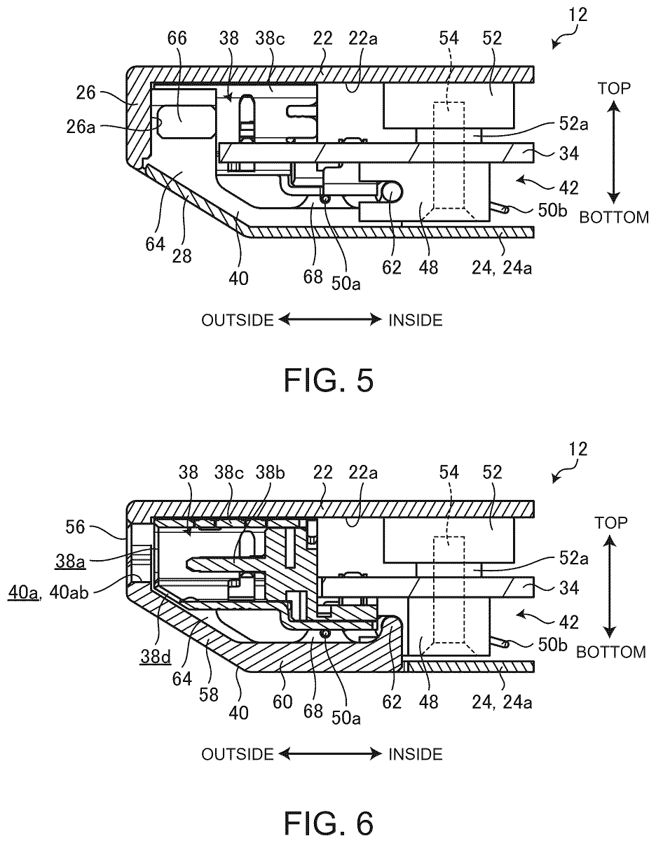

The chassis 12 has a horizontally elongated rectangular flat shape, and is composed of an upper plate 22, a lower plate 24, and a side plate 26 having the four peripheral sides. The side plate 26 is formed as an upright wall provided upright from the edge of the upper plate 22. In other words, the upper plate 22 and the side plate 26 are integrated together to form a shallow bathtub shape. The lower plate 24 has an inclined plate 28 (refer to FIG. 5) formed so as to approach the upper plate 22 outwardly until the end thereof substantially comes in contact with the lower end of the side plate 26. Therefore, the side plate 26 is thin relative to the thickness of the chassis 12, thus providing a preferable appearance. The side plate 26 has a thickness of, for example, approximately half that of the chassis 12. Although the inclined plate 28 is integral with the lower plate 24 and regarded as a part of the lower plate 24, the part of the lower plate 24 excluding the inclined plate 28 will be referred to as a bottom plate 24a (refer to FIG. 5).

The upper plate 22 of the chassis 12 is provided with a keyboard device 30 at the rear thereof and a touchpad 32 at the front thereof. Inside the chassis 12, a substrate 34 is provided at the rear, and a battery 36 is provided at the front, and further, a storage device, a communication device, a cooling device, and the like, which are not illustrated, are provided. The substrate 34 is fixed to an inner surface 22a (refer to FIG. 5) of the upper plate 22. The substrate 34 is a motherboard that controls the entire electronic apparatus 10. The upper plate 22 has a certain thickness to fix the keyboard device 30, the touchpad 32, the substrate 34, and the like thereto (refer to FIG. 5), and is configured to be integral with the side plate 26 thereby to provide high rigidity. The upper plate 22 is formed of a metal material to ensure particularly high rigidity, but may be made of a resin material, depending on conditions. In contrast, the lower plate 24 is basically required merely to cover the lower surface of the chassis 12, so that the lower plate 24 is thin (refer to FIG. 5) and has low rigidity in comparison with the upper plate 22.

The lateral width of the substrate 34 is slightly smaller than that of the chassis 12, and a receptacle connector 38 is attached to the right end in FIG. 1. The receptacle connector 38 is, for example, an HDMI (High Definition Multimedia Interface: registered trademark), and has standardized specifications and shape. The receptacle connector 38 may be a USB (Universal Serial Bus) or the like. In the example in FIG. 1, the receptacle connector 38 and the cover 40 are located at the right in the chassis 12, but may alternatively be located at the left, the front, or the rear. The receptacle connector 38 may be provided on a sub-substrate other than the substrate 34.

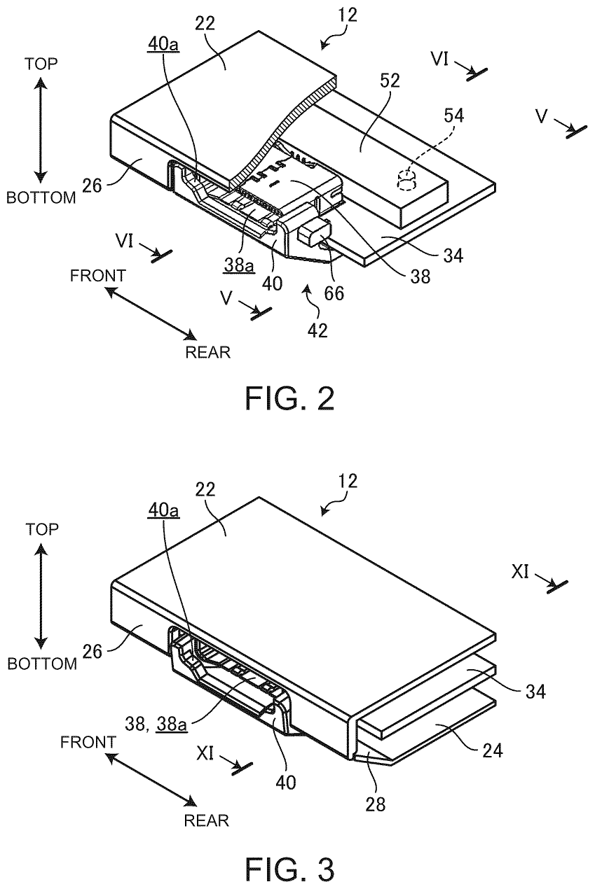

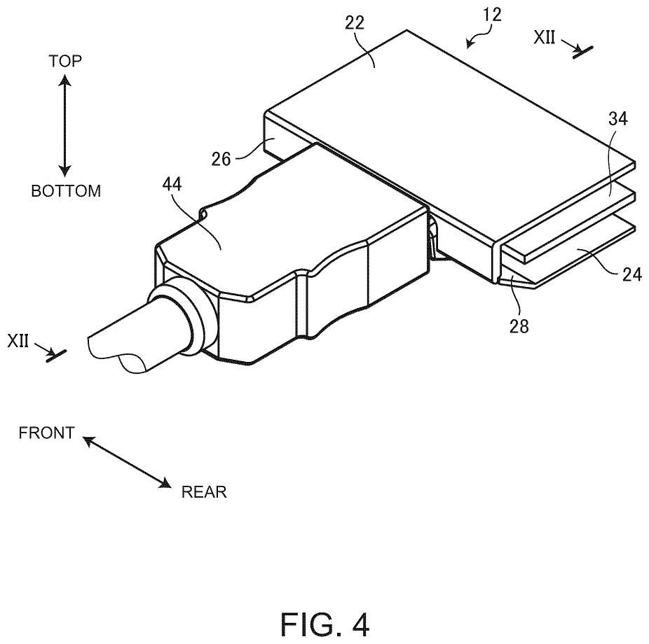

FIG. 2 is a partially cutaway perspective view illustrating the receptacle connector 38 and the surroundings thereof in the side plate 26 with the cover 40 closed. FIG. 3 is a perspective view illustrating the receptacle connector 38 and the surroundings thereof in the side plate 26 with the cover 40 open. FIG. 4 is a perspective view illustrating the receptacle connector 38 and the surroundings thereof in the side plate 26 with a plug connector 44 connected.

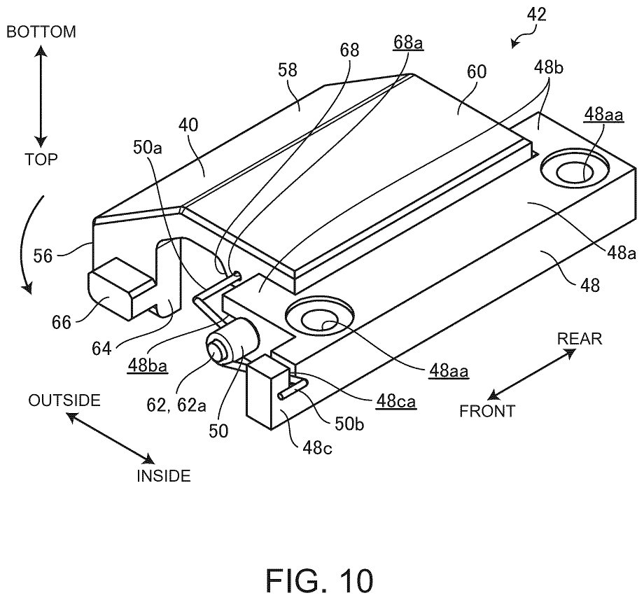

As illustrated in FIG. 2, the receptacle connector 38 is partly covered by the cover 40 in a closed state. The cover 40 is elastically urged upward, and maintained in the closed state when there is no external force. A cutout 40a is formed in the cover 40. Together with a block 48 (refer to FIG. 10) and a coil spring 50, the cover 40 constitutes a cover assembly 42. A plug insertion opening 38a of the receptacle connector 38 faces the outside of the chassis 12 and is partly exposed through the cutout 40a, but has at least the lower part thereof covered by the cover 40. In other words, the cover 40 and the cover assembly 42 having the cover 40 as a component thereof form the protection cover of the receptacle connector 38.

As illustrated in FIG. 3, the cover 40, which is an openable type, is opened by being slightly moved down to expose the plug insertion opening 38a to the bottom thereof. The cover 40 is opened by manually pushing down the cutout 40a or by manually holding the plug connector 44 and pushing down the cutout 40a.

As illustrated in FIG. 4, the plug connector 44 can be connected to the receptacle connector 38 by placing the cover 40 in the open state.

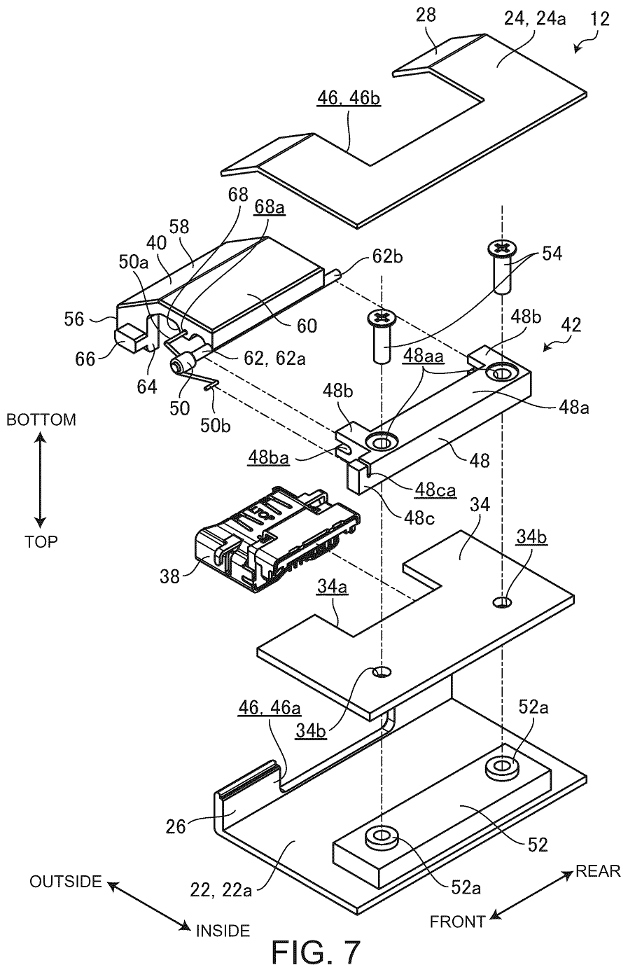

FIG. 5 is a sectional view taken along line V-V in FIG. 2. FIG. 6 is a sectional view taken along line VI-VI in FIG. 2. However, the illustrations in FIG. 5 and FIG. 6 include the upper plate 22, the lower plate 24, and the like, which are cut in FIG. 2. FIG. 7 is an exploded perspective view of the receptacle connector 38 and the surrounding components thereof.

The substrate 34 has a rectangular cutout 34a formed in an edge thereof. The receptacle connector 38 is attached to the substrate 34 by being partly fitted to the cutout 34a, which is the so-called mid-mount method, but may alternatively be attached to the substrate 34 without the cutout 34a, which is the so-called top-mount method. The plug insertion opening 38a faces the outside. Two screw holes 34b arranged in the front-rear direction are formed in the vicinity of the cutout 34a in the substrate 34. The receptacle connector 38 has a tongue portion 38b at a substantially vertical middle of the plug insertion opening 38a. The tongue portion 38b has electrode terminals on the upper and lower surfaces and protrudes outward. The receptacle connector 38 has a plug-holding cylindrical body 38c that forms the peripheral wall of the plug insertion opening 38a. The plug-holding cylindrical body 38c is generally made of a metal material and is electrically connected to ground. The plug-holding cylindrical body 38c has an inclined cutout 38d formed in a lower outer portion thereof in such a manner as to incline to form a gap of a substantially constant interval relative to the inner surface of an inclined cover 58.

The chassis 12 has a cover fitting cutout 46 formed to extend from a point in the side plate 26, where the plug insertion opening 38a is exposed, to the lower plate 24. The cover fitting cutout 46 is composed of an upper cutout 46a formed in the side plate 26 and a lower cutout 46b formed in the lower plate 24. The lower cutout 46b is formed from the inclined plate 28 to the bottom plate 24a, but may alternatively be formed only within the range of the inclined plate 28 if the inclination of the inclined plate 28 is gentle and long in the inward and outward directions.

A block-shaped intermediate fixing member 52 is fixed to the inner surface 22a of the upper plate 22. The intermediate fixing member 52 may be a separate piece from the upper plate 22 and fixed to the inner surface 22a by press-fitting, bonding, or the like, or may be integral with the upper plate 22. The lower surface of the intermediate fixing member 52 is provided with studs 52a arranged in the front-rear direction. The substrate 34 is held between the block 48 and the studs 52a of the intermediate fixing member 52.

Two fixing screws 54 pass through screw holes 48aa formed in the block 48, further pass through the screw holes 34b of the substrate 34, and are screwed to the studs 52a of the intermediate fixing member 52. In other words, the substrate 34, the block 48, and the intermediate fixing member 52 are tightened together and fixed by the screws 54. The screws 54 are small, e.g., size M2.

For ease of understanding, the cover 40 and the block 48 are illustrated separated in FIG. 7. However, when assembling the electronic apparatus 10, the cover 40, the coil spring (elastic member) 50, and the block 48 are pre-assembled into the cover assembly 42 (refer to FIG. 10).

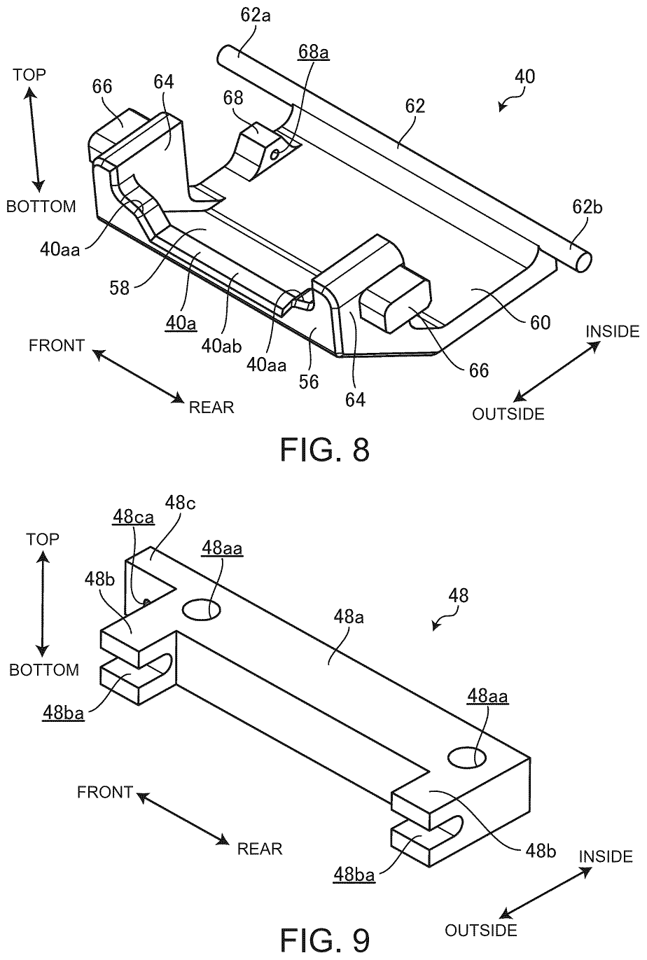

FIG. 8 is a perspective view of the cover 40. The cover 40 has a lateral cover 56 which forms the same surface as the side plate 26 when viewed in the closed state from outside, the inclined cover 58 which forms the same surface as the inclined plate 28, a lower cover 60 which forms the same surface as the bottom plate 24a, and a rotation shaft 62 formed along the inner edge of the lower cover 60. The connection between the lateral cover 56 and the inclined cover 58, and the connection between the inclined cover 58 and the lower cover 60 each have an obtuse angle. If the inclination of the inclined plate 28 is gentle and long in the inward and outward directions, the inclined cover 58 may be made long to match the inclined plate 28, and the lower cover 60 may be omitted. As the rotation shaft 62 journaled to the block 48 rotates, the cover 40 almost closes the cover fitting cutout 46 in the closed state, and exposes the plug insertion opening 38a in the open state.

The cutout 40a mentioned above is formed in the lateral cover 56. The cutout 40a has substantially two-stage slopes 40aa at the front and rear ends that narrow downward to match the lower end shape of the receptacle connector 38, and a cutout edge surface 40ab that is rather elongated in the front-rear direction is located between the slopes 40aa.

The cover 40 has, at the front and rear ends, reinforcing walls 64 which protrude upward from the inner surface of the lateral cover 56 to the upper surface of the inclined cover 58. The lateral cover 56 and the reinforcing walls 64 have equal heights. The reinforcing walls 64 have an appropriate width in the inward and outward directions, exhibiting high strength.

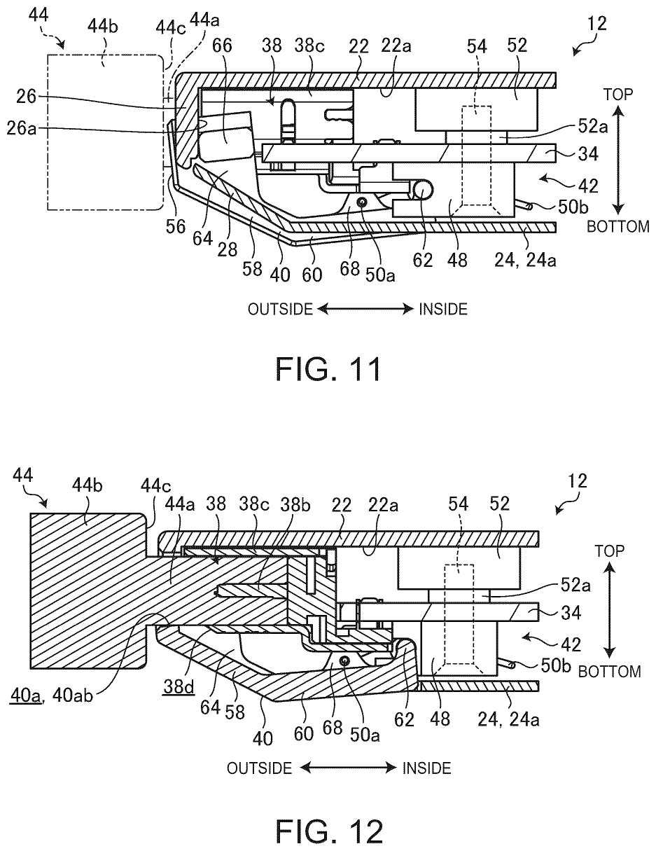

The reinforcing walls 64 are provided with protruding stoppers 66 spaced apart from each other in the front-rear direction. Each of the stoppers 66 is provided at the inner end and in the vicinity of the upper end of the reinforcing wall 64, and is slightly spaced from the outer surface of the lateral cover 56. The stopper 66 is substantially rectangular when viewed in the front-rear direction, has a moderate thickness in the vertical direction, and is thicker in the inward-outward direction, exhibiting high strength. When the cover 40 is in the open state, the stopper 66 comes in contact with the inner surface 26a of the side plate 26 (refer to FIG. 11) so as to restrict the displacement in the opening direction. The two outer corners of the stopper 66 are arc-shaped, thus making it possible to prevent damage to the inner surface 26a due to contact with the inner surface 26a and the functional loss of the stopper 66. The two inner corners of the stopper 66 do not have to be arc-shaped, and have C-shaped surfaces in one or more embodiments.

The rotation shaft 62 is shaped like a round bar having both ends thereof protruding from the lower cover 60. One end 62a of the rotation shaft 62 protrudes longer than the other end 62b, and the longer end is provided with the coil spring (refer to FIG. 7) 50. One end 50a and the other end 50b of the coil spring 50 have an L-shape. A spring engagement part 68, which has a mountain shape when viewed in the front-rear direction, is provided in the vicinity of the one end 62a on the upper surface of the lower cover 60. The one end 50a of the coil spring 50 engages with a spring hole 68a in the front-rear direction of the spring engagement part 68.

The cover 40 is made of a metal material such as an aluminum material, and each part thereof has a moderate thickness as illustrated in FIG. 6, and therefore exhibits high strength. Each part of the cover 40 is thicker than the lower plate 24, and especially the lower cover 60 in the vicinity of the rotation shaft 62 is thicker. The lateral cover 56 and the inclined cover 58 are thinner than the lower cover 60, but have approximately the same thickness as that of the upper plate 22, and both front and rear ends thereof are reinforced by the reinforcing walls 64, thus ensuring sufficient strength. The above-mentioned inclined cutout 38d forms the gap of a substantially constant interval relative to the inner surface of the inclined cover 58. The inclined cover 58 is thinner than the lower cover 60, and the range of the inclined cutout 38d can be limited as much as possible. The cover 40 may be made of a resin material or a composite material of metal and resin made by insert molding or the like as long as the strength requirements are met.

FIG. 9 is a perspective view of the block 48. As illustrated in FIG. 9 and FIG. 7, the block 48 has a main part 48a having a rectangular parallelepiped shape that is long in the front-rear direction, shaft support parts 48b protruding outward from both ends of the main part 48a, and a spring engagement piece 48c protruding in the front-rear direction from one end of the main part 48a. The above-mentioned two screw holes 48aa are formed side by side in the front-rear direction in the main part 48a. U-shaped shaft grooves 48ba, which open to the outside, are formed in the shaft support parts 48b. The one end 62a and the other end 62b of the rotation shaft 62 are fitted into the shaft grooves 48ba and journaled. The inner edge of the lower cover 60 fits between the two shaft support parts 48b with almost no gap, thus positioning the cover 40 in the front-rear direction. The cover 40 is made of a metal material such as stainless steel material and has high strength, but may be made of a resin material as long as strength requirements are met.

FIG. 10 is a perspective view of the cover assembly 42. As described above, the cover assembly 42 is composed of the cover 40, the coil spring 50, and the block 48. The cover 40 is journaled to the block 48, and urged by the coil spring 50 in the closing direction (in the direction indicated by the arc-shaped arrow in FIG. 10). The cover 40 may alternatively be structured so as to be latched in either of two positions, i.e., open or closed, rather than being elastically urged. The spring engagement piece 48c is placed in the vicinity of the inner side of the one end 62a of the rotation shaft 62. A spring groove 48ca that opens downward is formed in the spring engagement piece 48c. The other end 50b of the coil spring 50 engages with the spring groove 48ca. The other end 50b is L-shaped, so that the tip thereof abuts against the inner surface of the spring engagement piece 48c, thus preventing the coil spring 50 and the cover 40 from slipping off outward. The coil part of the coil spring 50 is slightly compressed, lightly elastically urging the cover 40 in one direction of the front-rear direction. This stabilizes the cover 40 by eliminating the rattling thereof in the front-rear direction.

In the cover assembly 42 described above, the cover 40 is journaled to the block 48 into one assembly unit rather than being journaled to the upper plate 22, the lower plate 24, or the side plate 26. Consequently, the chassis 12 does not require hinges or the like, and is therefore applicable to a wide variety of models independently of the shape of the chassis 12, thus providing high compatibility.

The block 48 is fixed to the substrate 34 by screwing the screws 54 into the studs 52a (refer to FIG. 7), and therefore can be detached from the substrate 34 by removing the screws 54. In other words, the cover assembly 42 is detachable and replaceable relative to the substrate 34.

The cover assembly 42 is assembled in advance into an assembly unit in the assembly process of the electronic apparatus 10, and therefore can be handled substantially as a single component, thus eliminating the need for attaching the coil spring 50 and the journaling of the rotation shaft 62. Basically, the cover assembly 42 can be attached to the chassis 12 simply by screwing the screws 54, making the attachment easier.

FIG. 11 is a sectional side view taken along line XI-XI in FIG. 3. As described above, the cover 40 is set to the open state by being pushed down, exposing the plug insertion opening 38a to the bottom. At this time, as illustrated in FIG. 11, the stopper 66 abuts against the inner surface 26a of the side plate 26 to limit the displacement, thus preventing excessive opening.

Even if the cover 40 is pushed down with a rather large force (e.g., a force that may be generated by a person in a normal operation), the stopper 66 will not deform because of its reasonable thickness in the inward-outward direction. A part of the pushing force by the stopper 66 is received by the inner surface 26a of the side plate 26. Further, a part of the force received by the cover 40 is received by the upper plate 22 from the rotation shaft 62 via the block 48, the substrate 34, and the intermediate fixing member 52. The upper plate 22 and the side plate 26 are made of a rather thick metal material and have high strength, and therefore will not deform. However, if the substrate 34 has sufficiently high strength or if another stud is provided in the vicinity of the intermediate fixing member 52, the intermediate fixing member 52 may be omitted. The lower plate 24 is not subjected to the force generated by an operation of opening the cover 40, and therefore may be thinner and have lower strength, as compared with the upper plate 22 and the side plate 26.

As indicated by the imaginary line, the plug connector 44 to be connected to the receptacle connector 38 includes a plug 44a to be inserted in the plug insertion opening 38a, and a housing 44b with the plug 44a protruding from an end thereof. The housing 44b has a sectional area that is larger than that of the plug 44a and has a stepped portion 44c between the housing 44b and the plug 44a. The stepped portion 44c is located slightly outward relative to the side plate 26. The cover 40 is configured so as not to come in contact with the stepped portion 44c in the open state in which the stopper 66 is in contact with the inner surface 26a. This is because the rotation shaft 62 is appropriately located inward, and the vertical position thereof is properly set.

The cover 40 has a small allowance gap relative to the lower surface of the plug 44a in a completely open state in which the stopper 66 is in contact with the inner surface 26a. This is because, considering variations in manufacture, the position where rotation is limited and the normal position where the plug connector 44 is inserted are set to be different. In other words, if there is no external force pushing down the cover 40, the urging force of the coil spring 50 will cause the cover 40 to rotate slightly upward from the state illustrated in FIG. 11 to the state illustrated in FIG. 12 below.

FIG. 12 is a sectional side view taken along line XII-XII in FIG. 4. The cover 40 is elastically urged upward, so that the cutout edge surface 40ab supports the plug 44a from below. The plug-holding cylindrical body 38c has an inclined cutout 38d formed in the outer lower portion thereof, so that the lower surface plate is shorter than the upper surface plate, and the plug 44a inserted into the plug-holding cylindrical body 38c may become unstable downward, but this is compensated for by the cutout edge surface 40ab providing support from below. The point of support by the cutout edge surface 40ab is in vicinity of the stepped portion 44c and further on the outer side relative to the outer end of the upper surface plate of the plug-holding cylindrical body 38c, thus effectively preventing the plug 44a from tilting counterclockwise in FIG. 12.

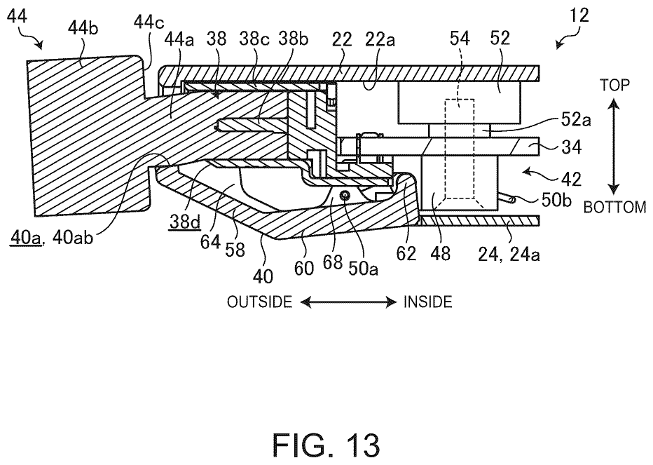

FIG. 13 is a sectional view of the receptacle connector 38 and the surrounding section thereof when the plug connector 44 is pushed down by a rather large force (e.g., a force that may be generated by a person in a normal operation). The plug connector 44 may be accidentally pushed down by a user when inserting the plug connector 44 into the receptacle connector 38 or while using the electronic apparatus 10 thereafter. This will cause the plug connector 44 to be displaced downward or subjected to a counterclockwise tilting force in FIG. 13.

Consequently, although the plug connector 44 is displaced downward as illustrated in FIG. 13, the cover 40 supporting the plug 44a from below is also pushed down and the stopper 66 comes in contact with the inner surface 26a of the side plate 26, thus preventing further downward displacement. The amounts of displacement of the plug connector 44 and the plug 44a are small, and the tongue portion 38b fitted to the tip of the plug 44a will not be subjected to stress, thus maintaining the electrical continuity of the electrode terminals. The force applied to the plug connector 44 is reliably received by the high-strength upper plate 22, the side plate 26, and the like in the same manner as when the cover 40 is pushed down (refer to FIG. 11). In a state in which the plug connector 44 is not subjected to an external force and is not displaced downward (refer to FIG. 12), the stopper 66 may abut against the inner surface 26a to restrict the movement.

The present invention is not limited to the embodiments described above, and may be of course freely modified within a scope that does not depart from the gist of the present invention.

### DESCRIPTION OF SYMBOLS

10 electronic apparatus
12 chassis
22 upper plate
24 lower plate
26 side plate
28 inclined plate
34 substrate
38 receptacle connector
38a plug insertion opening
38b tongue portion
38c plug-holding cylindrical body
38d inclined cutout
40 cover
40a cutout
40ab cutout edge surface
42 cover assembly
44 plug connector
44a plug
44b housing
44c stepped portion
46 cover fitting cutout
48 block
48b shaft support part
50 coil spring
52 intermediate fixing member
54 screw
56 lateral cover
58 inclined cover
60 lower cover
62 rotation shaft
64 reinforcing wall
66 stopper

What is claimed is:

1. An electronic apparatus comprising:
a flat chassis composed of an upper plate, a lower plate, and a side plate having four peripheral sides;
a substrate provided in the chassis;
a receptacle connector which is attached to the substrate and has a plug insertion opening directed to a side of the chassis;
a cover fitting cutout formed in the side plate of the chassis so as to extend from a point, where the plug insertion opening is exposed, to the lower plate; and
a cover assembly attached to the substrate,
wherein the cover assembly includes:
a block detachably fixed to the substrate, and
a cover which is journaled to the block and rotates to close the cover fitting cutout in a closed state and expose the plug insertion opening in an open state.

2. The electronic apparatus according to claim 1,
wherein the cover has a stopper that abuts against an inner surface of the side plate to restrict rotation in an opening direction.

3. The electronic apparatus according to claim 1,
wherein the side plate is formed as an upright wall provided upright from an edge of the upper plate,
the lower plate has an inclined plate formed so as to approach the upper plate sideways until an end thereof substantially comes in contact with a lower end of the side plate,
the cover has a lateral cover which forms the same surface as the side plate when viewed in the closed state from outside, and an inclined cover which forms the same surface as the inclined plate,
the receptacle connector includes a plug-holding cylindrical body which forms a peripheral wall of the plug insertion opening, and
the plug-holding cylindrical body has an inclined cutout formed in a lower side portion in such a manner as to provide a gap of a substantially constant interval relative to an inner surface of the inclined cover.

4. The electronic apparatus according to claim 1,
wherein downward displacement of a lower surface of a plug connector connected to the receptacle connector is restricted by the cover.

5. The electronic apparatus according to claim 1,
wherein an intermediate fixing member is fixed to an inner surface of the upper plate,
the substrate is held between the block and the intermediate fixing member, and
the substrate, the block, and the intermediate fixing member are tightened together and fixed by a screw.

6. The electronic apparatus according to claim 1,
wherein the cover assembly has an elastic member which elastically urges the cover in a closing direction.

7. The electronic apparatus according to claim 1,
wherein a plug connector to be connected to the receptacle connector includes a plug to be inserted into the plug insertion opening, and a housing with the plug protruding from an end thereof,
the housing has a sectional area which is larger than that of the plug and has a stepped portion between the housing and the plug, and
the cover does not come in contact with the stepped portion in an open state.

8. The electronic apparatus according to claim 1,
wherein the receptacle connector has a tongue portion provided with an electrode terminal at a substantially vertical middle of the plug insertion opening.
